(19) United States
(12) Patent Application Publication
(10) Pub. No.: US 2026/0140324 A1
(43) Pub. Date: May 21, 2026

(54) METHOD AND SYSTEM FOR ASSEMBLY AND CALIBRATION OF POLARIZATION-MAINTAINING FIBERS IN CO-PACKAGED OPTICS

(71) Applicant: FOCI FIBER OPTIC COMMUNICATIONS, INC., HSINCHU (TW)

(72) Inventor: Tai-Wei Yu, HSINCHU (TW)

(21) Appl. No.: 19/011,726

(22) Filed: Jan. 7, 2025

(30) Foreign Application Priority Data
Nov. 19, 2024 (TW) 113144498

(51) Int. Cl. G02B 6/36; G02B 6/024; G02B 6/06

(52) U.S. Cl. CPC G02B 6/3636; G02B 6/024; G02B 6/06; G02B 6/3616; G02B 6/3676

(57) ABSTRACT

A method and system for assembly and calibration of polarization-maintaining fibers in co-packaged optics is provided, the method includes the following steps: using a substrate with a plurality of V-shaped grooves arranged side by side, and placing a bare fiber segment of a polarization-maintaining fiber in each V-shaped groove; using a low-frequency vibrator to allow the bare fiber segment to move and rotate along the V-shaped groove, and controlling the length of the bare fiber segment extending out of the V-shaped groove; using an optical inspection lens set to monitor the continuous rotation, when the end-face of the bare fiber segment being rotated to a set angle, operating a first pressing assembly to press the bare fiber segment thereon; continuing to repeat the above steps until all the polarization-maintaining fibers being at the set angle, and then operating a second pressing assembly to press on the cladding segments.

### BACKGROUND OF THE INVENTION

### 1. Field of the Invention

The present invention relates generally to the technical field of polarization-maintaining fiber arrays, and more particularly, to a method and system for assembly and calibration of polarization-maintaining fibers in co-packaged optics.

### 2. The Prior Arts

Polarization-maintaining fibers are used as transmission media to transmit polarized light and have been widely used in aerospace, aviation, navigation, industrial manufacturing technology, communications and other fields. In interferometric optical fiber sensors based on optical correlation detection, the use of polarization-maintaining fibers can ensure that the linear polarization direction remains unchanged, improve the relevant signal-to-noise ratio, and achieve high-precision measurement of physical quantities.

Polarization-maintaining fiber can be divided into panda-type polarization-maintaining fiber, butterfly-type polarization-maintaining fiber, and elliptical-cladding type polarization-maintaining fiber according to the shape of the end-face stress zone. Panda-type polarization-maintaining fiber is commonly used in the market. FIG. 1 shows a schematic structural view of such a panda-type polarization-maintaining fiber array. This polarization-maintaining fiber array includes: a preset number of polarization-maintaining fibers 10, a substrate 20, and a cover plate 25. The polarization-maintaining fiber 10 includes a cladding segment 11 and a bare fiber segment 12 with the cladding removed. The upper surface of the substrate 20 is provided with a step 21 of a predetermined length. There is a preset number of V-shaped grooves 22 arranged side by side on the step 21. Each V-shaped groove 22 is used for placing the corresponding bare fiber segment 12 of the polarization-maintaining fiber 10. The cover plate 25 is arranged on the step 21, and the cover plate 25 covers the bare fiber segment 12 of each polarization-maintaining fiber 10. The cover plate 25, the substrate 20, and the bare fiber segment 12 are fixed and molded by ultraviolet light-curing glue to form a co-packaged polarization-maintaining fiber array structure.

FIG. 2 shows a partial end-face view of a polarization-maintaining fiber array, wherein the center of the bare fiber segment 12 of the panda-type polarization-maintaining fiber 10 is the core 13, and two stress zones 14 are symmetrically distributed at both sides of the core 13, the straight line connecting the centers of the two stress zones 14 is the slow axis 15, and the straight line passing through the centers of the plurality of cores 13 is the fast axis 16. According to the polarization-maintaining fiber array specification, the angle β between the slow axis 15 and the fast axis 16 of each polarization-maintaining fiber 10 must be within a set angle, that is, the angle β is within ±2 degrees. Otherwise, the extinction ratio of the polarization-maintaining fiber will be reduced and the transmission quality of the polarization-maintaining fiber array will be affected.

Therefore, during the assembly process of the polarization-maintaining fiber array, calibration operations must be performed to ensure that the angle of each polarization-maintaining fiber 10 in the V-shaped groove 22 on the substrate 20 conforms to the set value. However, the currently used calibration method uses a fiber rotating clamp to fix the cladding segment 11 of the polarization-maintaining fiber 10. While rotating the fiber rotating clamp, a set of optical inspection lenses is used to monitor the polarization angle of the end-face of the bare fiber segment 12 in the V-shaped groove 22. When the angle reaches the required angle, the rotation is stopped and the position is fixed. After all the polarization-maintaining fibers are calibrated, glue is dispensed over a large area, the cover 25 is covered, and finally photo-curing is performed. However, the operation efficiency of this calibration method is slow. As the number of polarization-maintaining fibers included in optical fiber arrays is increasing, the aforementioned method is gradually unable to meet the needs of mass production.

### SUMMARY OF THE INVENTION

A primary objective of the present invention is to provide a method and system for assembly and calibration of polarization-maintaining fibers in co-packaged optics, which can simultaneously perform angle calibration operations on side-by-side polarization-maintaining fibers during the process, thus greatly reducing the time for the calibration of the polarization-maintaining fiber array, thereby improving the overall assembly production efficiency.

In order to achieve the aforementioned objective, the present invention provides the following technical solution:

The present invention provides a method for assembly and calibration of polarization-maintaining fibers in co-packaged optics, including the following steps: using a substrate with a plurality of V-shaped grooves arranged side by side, and placing a bare fiber segment of a polarization-maintaining fiber in each V-shaped groove; using a low-frequency vibrator to allow the bare fiber segment to move and rotate along the V-shaped groove, and controlling the length of the bare fiber segment extending out of the V-shaped groove; using an optical inspection lens set to monitor the continuous rotation of the plurality of V-shaped grooves, when the end-face of the bare fiber segment being rotated to a set angle, operating a first pressing assembly to press the bare fiber segment thereon; continuing to repeat the above optical inspection steps until all the polarization-maintaining fibers being at the set angle, and then operating a second pressing assembly to press the cladding segment of the plurality of polarization-maintaining fibers. As such, the present invention can complete the calibration and alignment operation of side-by-side polarization-maintaining fibers.

In a preferred embodiment, the substrate is fixed on a carrier platform, the carrier platform in in a tilted state and provided with a carrier, the carrier is provided with a plurality of side-by-side accommodating grooves, the number of the accommodating grooves is equal to the number of the V-shaped groove, the V-shaped groove carries the bare fiber segment and the accommodating groove carries the cladding segment, and the carrier platform and the carrier are tilted at an angle, so that the polarization-maintaining fiber tilts from the cladding segment toward the bare fiber segment.

In a preferred embodiment, the carrier is installed on at least one low-frequency vibrator; the low-frequency vibrator vibrates the carrier when operating, causing the cladding segment to rotate and move in the accommodating groove and causing the bare fiber segment to move and rotate along the V-shaped groove.

In a preferred embodiment, the carrier platform is provided with a transparent stopper in the extending direction facing the V-groove, and the transparent stopper limits the length of the bare fiber segment extending out of the V-shaped groove.

In a preferred embodiment, the first pressing assembly is provided with a plurality of side-by-side probe units, each of the probe units can be raised and lowered independently, and the lowered probe unit presses down and fixes the corresponding bare fiber segment.

In a preferred embodiment, after completing a plurality of calibration operations of the polarization-maintaining fibers, glue is dispensed on the bare fiber segments in the V-shaped groove, and a cover plate is used to cover the substrate and the bare fiber segments, and then light curing and shaping is performed to form a single-row polarization-maintaining fiber array.

In a preferred embodiment, when packaging a multi-layer multi-row polarization-maintaining fiber array, a plurality of single-row polarization-maintaining fiber arrays can be directly stacked, and the stacking can be formed by gluing and fixing the adjacent single-row polarization-maintaining fiber arrays with cover plates adjacent to each other.

In a preferred embodiment, when packaging a multi-row polarization-maintaining fiber array, a plurality of single-row polarization-maintaining fiber arrays can be directly stacked, and the stacking can be formed by gluing and fixing the substrate of the top single-row polarization-maintaining fiber array with the cover plates of the bottom single-row polarization-maintaining fiber array to each other, and vice versa.

Furthermore, the present invention also provides a system for assembly and calibration of polarization-maintaining fibers in co-packaged optics, applicable to calibrating the angles of a plurality of polarization-maintaining fibers in a plurality of V-shaped grooves arranged side by side on a substrate, the polarization-maintaining fiber having a bare fiber segment and a cladding segment, comprising: a machine platform, equipped with at least one low-frequency vibrator; a carrier platform, provided on the machine platform, able to attach to and fix the substrate, and having a transparent stopper facing the substrate; a carrier, installed above the machine platform through the low-frequency vibrator, provided with side-by-side accommodating grooves, wherein the bare fiber segment is located in the V-shaped groove, and the cladding segment is located in the accommodating groove, and the transparent stopper limits the length of the bare fiber segment extending out of the V-shaped groove; a first pressing assembly, provided on the machine platform, comprising a first driving device, a cantilever, and a plurality of probe units provided on the cantilever; the first driving device able to drive the cantilever to rise and fall, and the probe able to rise and fall independently, able to exert pressure on the corresponding bare fiber segment when lowered; a second pressing assembly, located on the machine platform, comprising a second driving device and a pressing part, the second driving device able to raise drive the pressing part to rise and fall, and able to exert pressure on the cladding segment; an optical inspection lens set, provided on the machine platform and located correspondingly to the substrate, and being used for photographing the end-face of the bare fiber segment.

In a preferred embodiment, the bottom of the machine platform is provided with a plurality of support feet, and the connection position between the support feet and the machine platform is provided with an adjustment assembly, the adjustment assembly can adjust the tilt angle of the machine platform, the tilt angle is to tilt the carried polarization-maintaining fiber from the cladding segment towards the bare fiber segment.

In a preferred embodiment, two low-frequency vibrators are provided and the top ends of the two low-frequency vibrators are respectively connected to both sides of the bottom of the carrier through slidable connectors, and the bottom of the low-frequency vibrator is fixed on the machine platform.

In a preferred embodiment, the low-frequency vibrator is a voice coil motor.

Compared with the prior art, the method and system for assembly and calibration of polarization-maintaining fibers in co-packaged optics of the present invention can simultaneously perform angle calibration operations on a plurality of side-by-side polarization-maintaining fibers during the calibration process, instead of the conventional one-by-one method. With the increasing number of side-by-side polarization-maintaining fibers in the polarization-maintaining fiber array structure, the present method can greatly shorten the calibration time of a single-row polarization-maintaining fiber array, thereby improving the assembly and production efficiency of the overall polarization-maintaining fiber array. With the emergence of multi-layer polarization-maintaining fiber arrays, such an improvement in production efficiency will help make products more market competitive.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a polarization-maintaining fiber array structure.

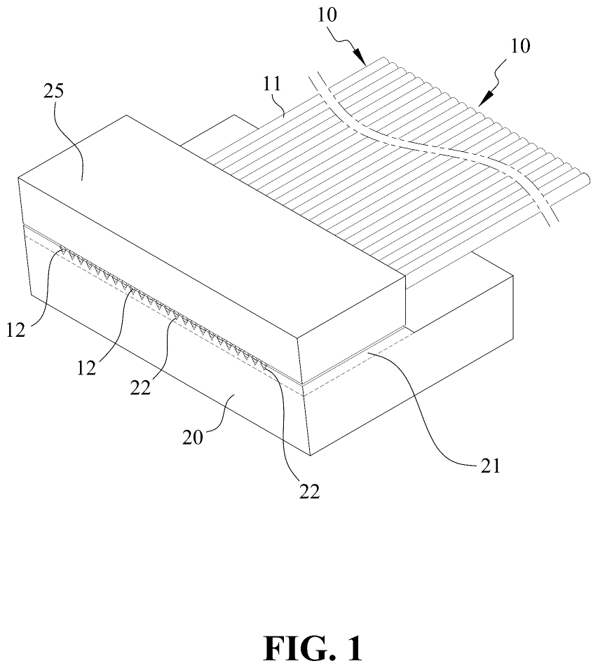

FIG. 2 is an enlarged view of a partial end-face of a polarization-maintaining fiber array.

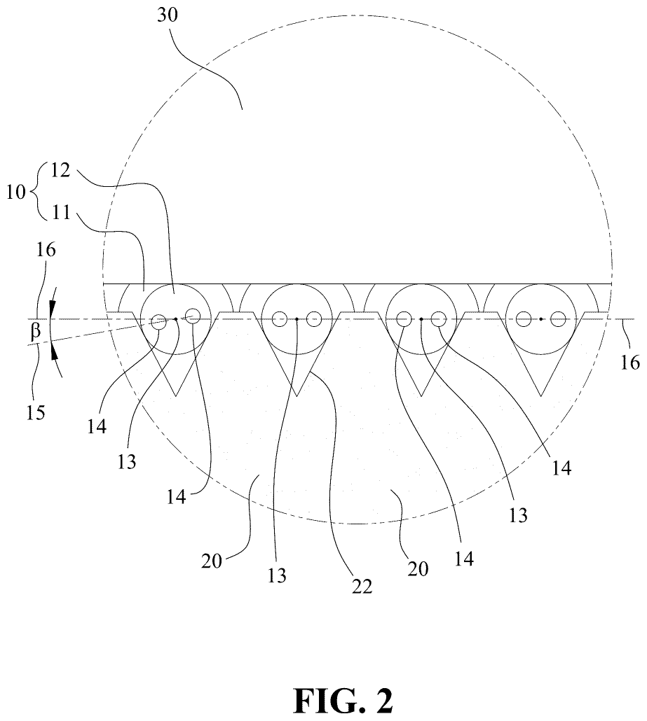

FIG. 3 is a schematic structural view of the polarization-maintaining fiber before calibration according to the present invention.

FIG. 4 is a flow chart of the assembly and calibration method of the present invention.

FIG. 5 is a schematic view of the structure corresponding to step S01 of the assembly and calibration method of the present invention.

FIG. 6 is a schematic view of the structure corresponding to step S02 of the assembly and calibration method of the present invention.

FIG. 7 is an enlarged schematic view of the structure corresponding to step S03 of the assembly and calibration method of the present invention.

FIG. 8 is a schematic view of the structure corresponding to step S04 of the assembly and calibration method of the present invention.

FIG. 9 is a schematic view of a first embodiment of the present invention applied to a multi-layer polarization-maintaining fiber array.

FIG. 10 is a schematic view of a second embodiment of the present invention applied to a multi-layer polarization-maintaining fiber array.

FIG. 11 is a perspective schematic view of the assembly and calibration system of the present invention.

FIG. 12 is a side view of the assembly and calibration system of the present invention.

FIG. 13 is a partial schematic view of the first and second pressing assemblies of the assembly and calibration system of the present invention;

FIG. 14 is a partial enlarged schematic view of the probe unit of the first pressing assembly in the assembly and calibration system of the present invention, with the transparent stopper on the carrier platform represented by an imaginary line.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

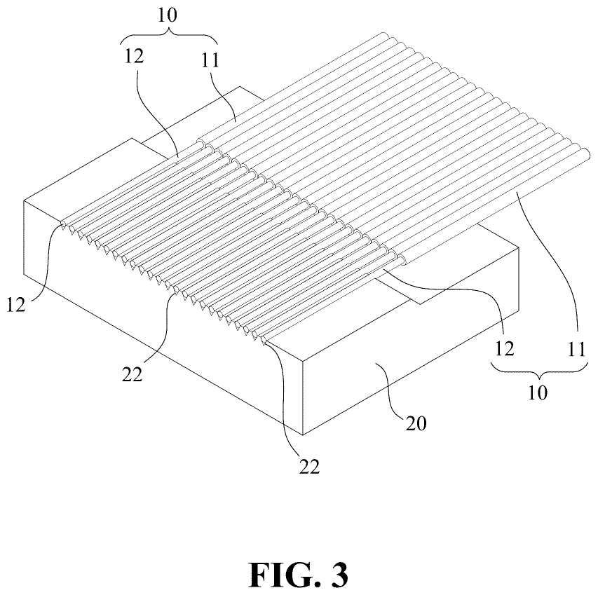

As shown in FIG. 3, the assembly and calibration method of polarization-maintaining fibers in co-packaged optics of the present invention can quickly and accurately perform the assembly and calibration method when the bare fiber segments 12 of the plurality of polarization-maintaining fibers 10 are located in the V-shaped grooves 22 on the substrate 20. The angle of each bare fiber segment 12 in the V-shaped groove 22 is calibrated to ensure that the angle formed by the slow axis of each polarization-maintaining fiber 10 and the line connecting the centers of the plurality of fiber cores is within ±2 degrees.

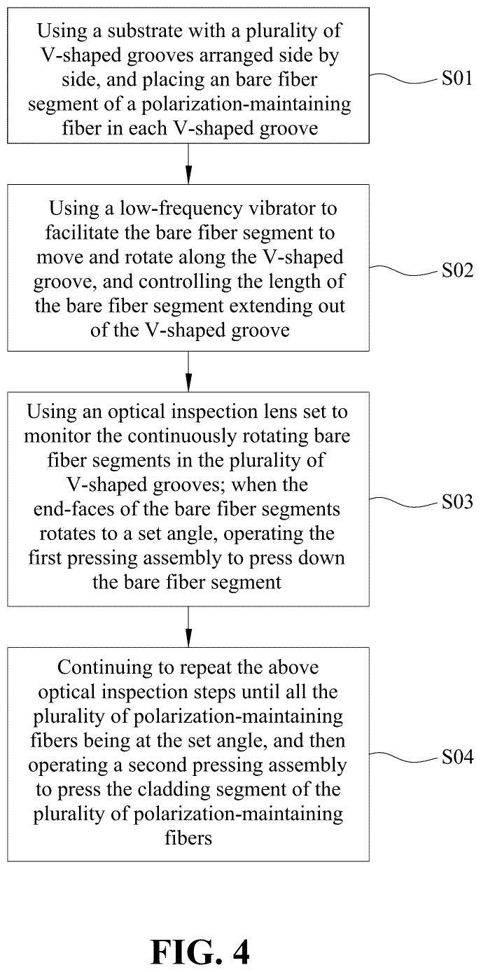

FIG. 4 shows a flow chart of the assembly and calibration method of the polarization-maintaining fiber of the co-packaged optics of the present invention. The steps of the calibration method are:

Step S01: Using a substrate with a plurality of V-shaped grooves arranged side by side, and placing an bare fiber segment of a polarization-maintaining fiber in each V-shaped groove;

Step S02: Using a low-frequency vibrator to facilitate the bare fiber segment to move and rotate along the V-shaped groove, and controlling the length of the bare fiber segment extending out of the V-shaped groove;

Step S03: Using an optical inspection lens set to monitor the continuously rotating bare fiber segments in the plurality of V-shaped grooves; when the end-faces of the bare fiber segments rotates to a set angle, operating the first pressing assembly to press down the bare fiber segment; and

Step S04: Continuing to repeat the above optical inspection steps until all the plurality of polarization-maintaining fibers being at the set angle, and then operating a second pressing assembly to press the cladding segment of the plurality of polarization-maintaining fibers. As such, the angle calibration of a single row of parallel polarization-maintaining fibers can be performed simultaneously.

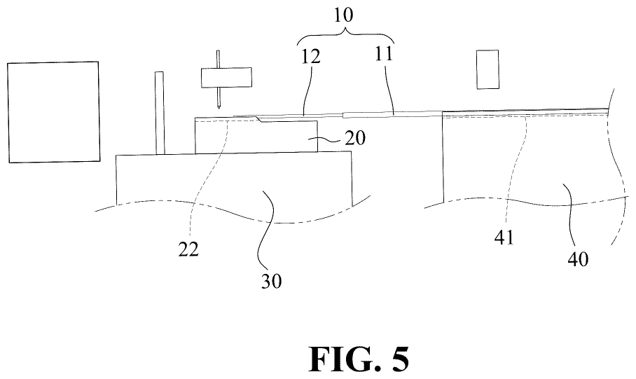

The following describes each step detail. As shown in FIG. 5, in step S01, the present invention uses a carrier platform 30 to carry the substrate 20. A vacuum adsorption device can be provided on the carrier platform 30 to absorb the substrate 20 and temporarily holds the substrate in place, and the V-shaped groove 22 on the substrate 20 is used for the bare fiber segment 12 to be placed thereon. In addition, the present invention is also provided with a carrier 40, and the carrier 40 is provided with a plurality of side-by-side accommodating grooves 41. The number of the accommodating grooves 41 is the same as that of the V-shaped grooves 22. The accommodating grooves 41 are used to carry the cladding segments 11 of the polarization-maintaining fibers 10. In the present embodiment, the cross-segment of the accommodating grooves 41 is also a V-shaped groove. The V-shaped grooves 22 and the accommodating grooves 41 facilitate the centers of the polarization-maintaining fibers 10 placed in the accommodating grooves 41 are on the same straight line. In addition, the carrier platform 30 and the carrier 40 have an inclination angle, i.e., tilting, which causes the polarization-maintaining fiber 10 placed thereon to tilt from the cladding segment 11 to the bare fiber segment 12.

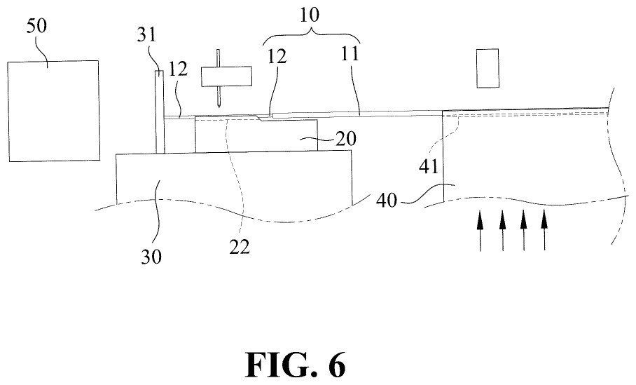

As shown in FIG. 6, in step S02, the present invention installs at least one low-frequency vibrator on the carrier 40. In addition, the carrier platform 30 is also provided with a transparent stopper 31 in the extending direction facing the V-groove 22. A low-frequency vibrator is used to drive the carrier 40 to generate slight low-frequency vibrations. This method is to set a specific frequency and operate with the aforementioned tilting angle, so that the cladding segment 11 can linearly move and rotate in the accommodating groove 41, prompting the bare fiber segment 12 to also move along the V-shaped groove 22 and finally extend out of the V-shaped groove 22, and the transparent stopper 31 limits the length of the bare fiber segment 12 allowed to extend out of the V-shaped groove 22. In the present embodiment, although the vibration of the carrier 40 is used to drive the movement and rotation of the bare fiber segment 12 on the carrier platform 30, it is not limited therein. The carrier 40 and the carrier platform 30 can also be combined so that the polarization-maintaining fiber 10 can also be moved and rotated during vibration.

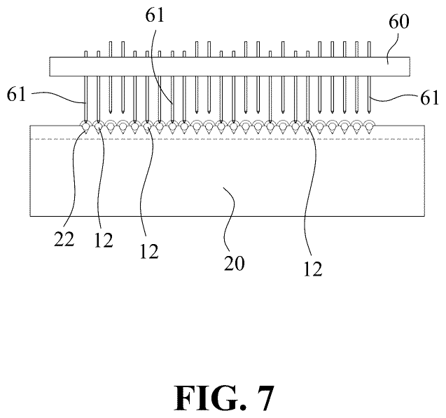

In step S03, when the bare fiber segment 12 contacts the transparent stopper 31, because the low-frequency vibrator continues to operate, the bare fiber segment 12 will not move at this time and can only rotate around the axis. At this time, the optical inspection lens set 50 arranged in front of the transparent stopper 31 is used to capture the end-face image of the bare fiber segment 12 in the V-shaped groove 22, and a back-end computer program is used for monitoring and interpretation. When the end-face of a specific bare fiber segment 12 has been rotated to the correct angle, that is, when the angle between the short axis and the long axis is at the set value, as shown in FIG. 7, the first pressing assembly 60 is driven to press the bare fiber segment 12 thereon. In the present embodiment, the first pressing assembly 60 is provided with a plurality of side-by-side probe units 61, and each probe unit 61 can be lowered independently. The present invention lowers a specific probe unit 61 so as to press on to fix the corresponding bare fiber segment 12 in place, so that the pressed bare fiber segment 12 can no longer rotate. However, the pressing down of a probe unit 61 does not affect the rotation of other bare fiber segments 12 that have not yet reached the correct angle. It will not enter the next step until the plurality of polarization-maintaining fibers 10 are at the correct angle and pressed by the probe unit 61.

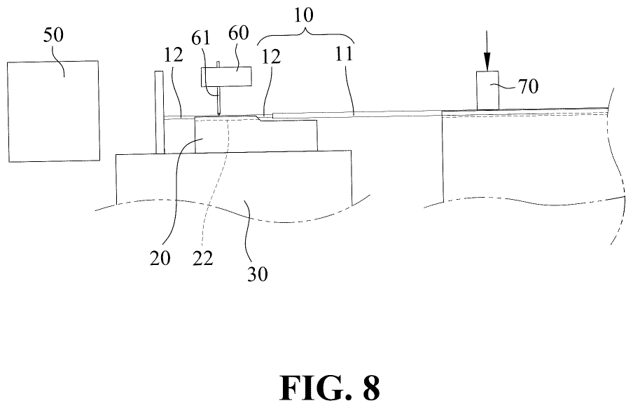

As shown in FIG. 8, in step S04, when all the bare fiber segments 12 are pressed down by the probe units 61 of the first pressing assembly 60, the end-faces of the plurality of polarization-maintaining fibers 10 are all located at the set angle. Then, the second pressing assembly 70 is operated to press on the cladding segment 11 of the plurality of polarization-maintaining fibers 10, and the positions of all the plurality of polarization-maintaining fibers 10 on the substrate 20 are fixed simultaneously, so as to achieve the objective to calibrate the plurality of polarization-maintaining fibers arranged side by side.

After completing the plurality of polarization-maintaining fiber calibration operations, all probe units 61 of the first pressing assembly 60 will be disengaged from the bare fiber segment 12, and subsequent processing procedures of dispensing glue, placing upper cover plate, and light curing will be performed. These subsequent procedures are similar to prior arts, so only a brief summary will be included here. First, glue is applied to the bare fiber segment 12 in the V-shaped groove 22, and a cover plate is used to cover the substrate 20 and the bare fiber segment 12. Finally, ultraviolet light (UV) is applied. Light curing molding is used to form a single-row polarization-maintaining fiber array. During the process, the optical inspection lens set 50 is also used for monitoring at different stages. In addition, after completion, the segments of the bare fiber segments 12 extending out of the substrate 20 are cut off and the end-faces are flattened by grinding.

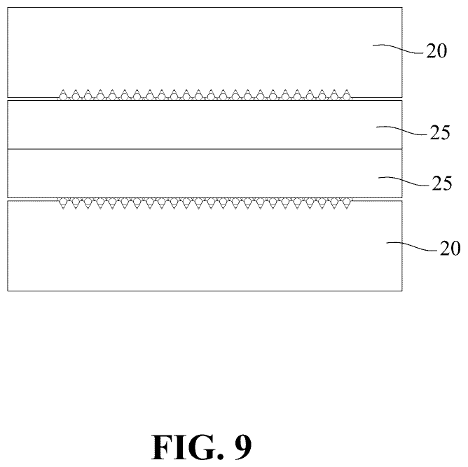

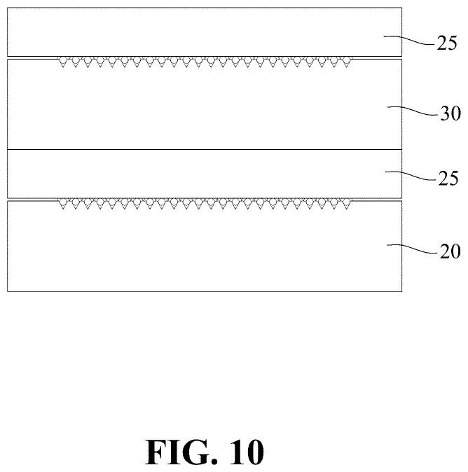

The aforementioned operation is mainly used in the assembly operation of single-row polarization-maintaining fiber arrays. When packaging a multi-layer, multi-row polarization-maintaining fiber array, a plurality of single-row polarization-maintaining fiber arrays can be directly stacked. During the process, the optical inspection lens set can be used to ensure the correctness of the stacking position. As shown in FIG. 9, the stacking can be formed by gluing and fixing the adjacent single-row polarization-maintaining fiber arrays with cover plates 25 adjacent to each other. Alternatively, as shown in FIG. 10, the stacking can be formed by gluing and fixing the substrate 20 of the top single-row polarization-maintaining fiber array with the cover plates 25 of the bottom single-row polarization-maintaining fiber array to each other. Therefore, the calibration method of the present invention can also be applied to multi-layer polarization-maintaining fiber arrays to shorten the assembly time required.

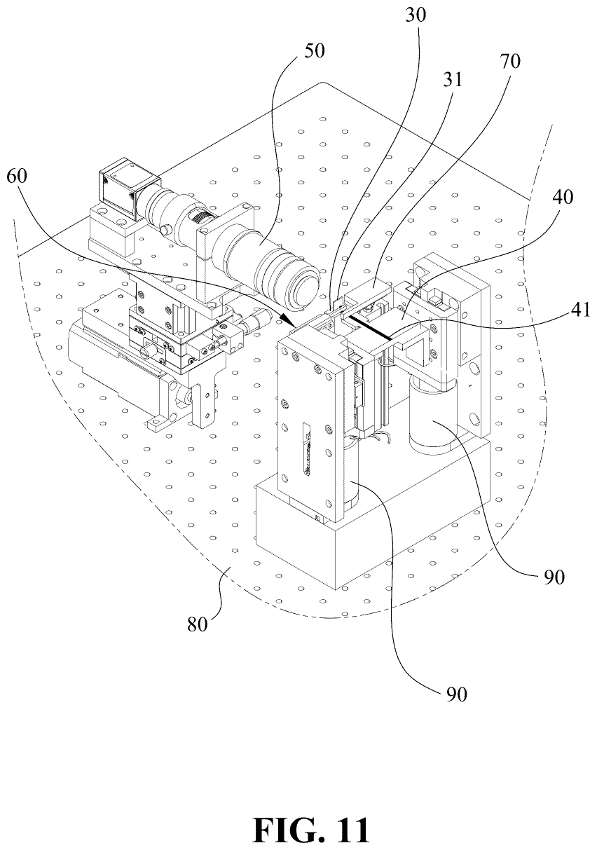

FIG. 11 shows a three-dimensional view of one of the actual structures of the system for assembly and calibration of polarization-maintaining fiber in co-packaged optics according to the present invention. The system for assembly and calibration of polarization-maintaining fiber in co-packaged optics of the present invention includes a carrier platform 30, a carrier 40, an optical inspection lens set 50, a first pressing assembly 60, and a second pressing assembly 70, and all the above components are all arranged on a machine platform 80.

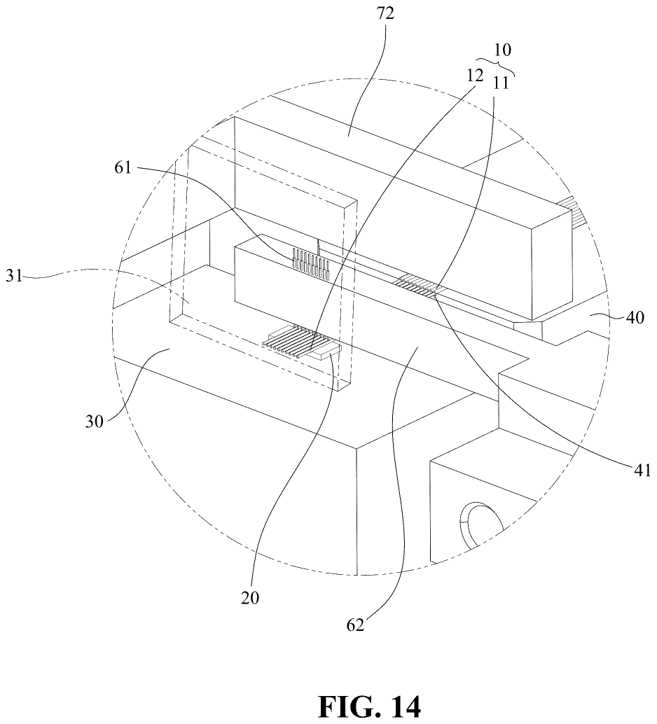

The machine platform 80 is also provided with at least one low-frequency vibrator 90. In the present embodiment, the carrier platform 30 is fixed on the machine platform 80. The carrier platform 30 is responsible for adsorbing and fixing the substrate 20, and a transparent stopper 31 is provided on the carrier platform 30 facing the substrate 20. The carrier 40 is installed on the machine platform 80 through the low-frequency vibrator 90. The carrier 40 is provided with side-by-side accommodating grooves 41. In the present embodiment, the accommodating grooves 41 are also V-shaped and are of the size corresponding to the outer diameter of the cladding segment 11. Before performing the calibration operation, other components can be used to move the polarization-maintaining fiber 10 here, as shown in FIG. 14, wherein the bare fiber segment 12 is located in the V-shape groove 22 on the substrate 20, the cladding segment 11 is located in the accommodating groove 41, and the transparent stopper 31 limits the exposed length of the bare fiber segment 12 extending out of the V-shaped groove 22, but the transparent stopper 31 does not affect the image captured by the optical inspection lens set 50.

In addition, in the present embodiment, two low-frequency vibrators 90 are included. The top ends of the two low-frequency vibrators 90 are respectively coupled to both sides of the bottom of the carrier 40 with slidable L-shaped connectors 91, and the bottom of the low-frequency vibrator 90 is fixed on the machine platform 80. The low-frequency vibrator 90 is a voice coil motor. The present invention uses two low-frequency vibrators 90 to vibrate the carrier 40 at a specific frequency during operation, thereby causing the polarization-maintaining fiber 10 on the carrier 40 can be moved and rotated. For example, two low-frequency vibrators 90 vibrate at different frequencies to cause the cladding segment 11 on the accommodating groove 41 to rotate clockwise or counterclockwise.

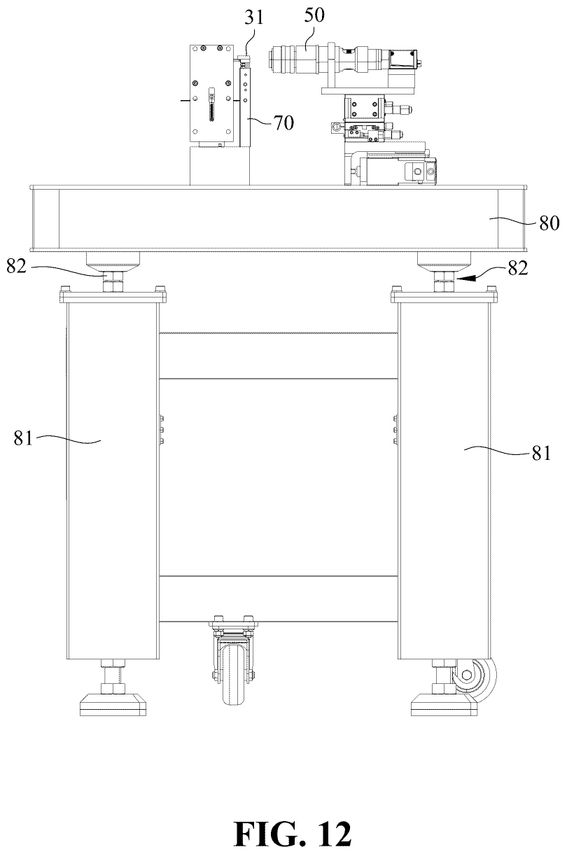

As shown in FIG. 12, the bottom of the machine platform 80 is also provided with a plurality of support feet 81. The connection position between the support feet 81 and the machine platform 80 is provided with an adjustment assembly 82. The adjustment assembly 82 can be a telescopic rod controlled by a servo motor, hydraulic cylinder, or screw set, etc. The inclination angle of the machine platform 80 can be controlled by adjusting the extended length of the adjustment assembly 82. The inclination angle enables the polarization-maintaining fiber 10 carried in the aforementioned system to tilt from the cladding segment 11 towards bare fiber segment 12.

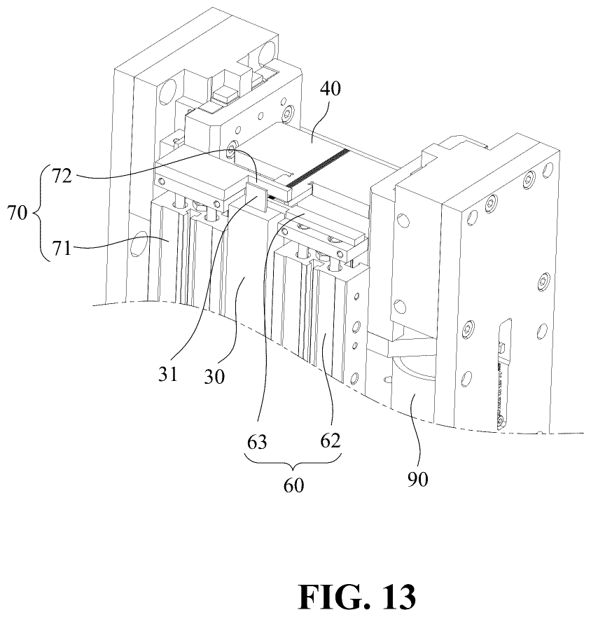

FIG. 13 shows a partial enlarged view of the first pressing assembly 60 and the second pressing assembly 70. The first pressing assembly 60 is disposed on the machine platform 80 and is located adjacent to the carrier platform 30. The first pressing assembly 60 includes a first driving device 62, a cantilever 63, and a plurality of probe units 61 disposed on the cantilever 63 (as shown in FIG. 14). The probe unit 61 can be driven up and down independently by other components. When the probe unit 61 is lowered, it can exert pressure on the corresponding bare fiber segment 12 to fix the bare fiber segment at a confirmed (i.e., calibrated) angle.

The second pressing assembly 70 is also provided on the machine platform 80 and is located adjacent to the carrier 40. The second pressing assembly 70 includes a second driving device 71 and a pressing part 72 that is driven by the second driving device 71 to move up and down. When the second driving device 71 drives the pressing part 72 downward, the pressing part 72 presses the cladding segments of a plurality of polarization-maintaining fibers to fix the position of all polarization-maintaining fibers 10.

The optical inspection lens set 50 is provided on the machine platform 80, and located correspondingly to the substrate 20. The optical inspection lens set 50 is used to photograph the end-face of the bare fiber segment to ensure whether the polarization angle is correct. In the present embodiment, since the transparent stopper 31 is made of transparent glass material, it does not affect the end-face image captured by the optical inspection lens set 50.

The present invention thereby utilizes the tilted state set by the machine platform 80 and in combination with the operation of the low-frequency vibrator 90 to enable the cladding segment 11 of the polarization-maintaining fiber 10 on the carrier 40 to be vibrated to move and rotate, and enable the bare fiber segment 12 to move and extend along the V-shaped groove 22 until the end surface of the bare fiber segment 12 contacts the transparent stopper 31. However, the low-frequency vibrator 90 continues to operate subsequently, which makes the polarization-maintaining fiber 10 retains in rotation state, so that the angle of the end-face of the bare fiber segment 12 can be checked at any time by using the optical inspection lens set 50. When the end-face of one of the bare fiber segments 12 is at the correct angle, the first pressing assembly 60 controls the corresponding probe unit 61 to press down to fix the position of the bare fiber segment 12. As all polarization-maintaining fibers 10 are calibrated, the second pressing assembly 70 presses down on the cladding segment 11 to fix the positions of all the polarization-maintaining fibers 10, thereby completing the calibration operation of the polarization-maintaining fibers 10.

In summary, the method and system for assembly and calibration of polarization-maintaining fiber in co-packaged optics according to the present invention utilizes the carrier platform 30 and the carrier 40 to carry a plurality of polarization-maintaining fibers simultaneously, and utilizes the low-frequency vibrator 90 in combination with the optical inspection lens set 50, the end-face of each polarization-maintaining fiber 10 on the substrate 20 is quickly calibrated until the calibration operation of all polarization-maintaining fibers 10 are calibrated. Instead of the conventional method of calibrating individual fibers one by one, the present invention greatly improves the production efficiency and precision.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for assembly and calibration of polarization-maintaining fibers in co-packaged optics, comprising the following steps:
using a substrate with a plurality of V-shaped grooves arranged side by side, and placing a bare fiber segment of a polarization-maintaining fiber in each V-shaped groove;
using a low-frequency vibrator to allow the bare fiber segment to move and rotate along the V-shaped groove, and controlling the length of the bare fiber segment extending out of the V-shaped groove;
using an optical inspection lens set to monitor the continuous rotation of the plurality of V-shaped grooves, when the end-face of the bare fiber segment being rotated to a set angle, operating a first pressing assembly to press the bare fiber segment thereon;
continuing to repeat the above optical inspection steps until all the polarization-maintaining fibers being at the set angle, and then operating a second pressing assembly to press the cladding segment of the plurality of polarization-maintaining fibers.

2. The method for assembly and calibration of polarization-maintaining fibers in co-packaged optics according to claim 1, wherein the substrate is fixed on a carrier platform, the carrier platform is in a tilted state and provided with a carrier, the carrier is provided with a plurality of side-by-side accommodating grooves, the number of the accommodating grooves is equal to the number of the V-shaped grooves, the V-shaped groove carries the bare fiber segment and the accommodating groove carries the cladding segment, and the carrier platform and the carrier are tilted at an angle, so that the polarization-maintaining fiber tilts from the cladding segment toward the bare fiber segment.

3. The method for assembly and calibration of polarization-maintaining fibers in co-packaged optics according to claim 2, wherein the carrier is installed on at least one low-frequency vibrator; the low-frequency vibrator vibrates the carrier when operating, causing the cladding segment to rotate and move in the accommodating groove and causing the bare fiber segment to move and rotate along the V-shaped groove.

4. The method for assembly and calibration of polarization-maintaining fibers in co-packaged optics according to claim 2, wherein the carrier platform is provided with a transparent stopper in the extending direction facing the V-groove, and the transparent stopper limits the length of the bare fiber segment extending out of the V-shaped groove.

5. The method for assembly and calibration of polarization-maintaining fibers in co-packaged optics according to claim 1, wherein the first pressing assembly is provided with a plurality of probe units arranged side-by-side, each of the probe units can be raised and lowered independently, and the lowered probe unit presses down and fixes the corresponding bare fiber segment.

6. The method for assembly and calibration of polarization-maintaining fibers in co-packaged optics according to claim 1, wherein after completing a plurality of calibration operations of the polarization-maintaining fibers, glue is dispensed on the bare fiber segments in the V-shaped groove, and a cover plate is used to cover the substrates and the bare fiber segments, and then light curing and shaping is performed to form a single-row polarization-maintaining fiber array.

7. The method for assembly and calibration of polarization-maintaining fibers in co-packaged optics according to claim 6, wherein when packaging a multi-layer multi-row polarization-maintaining fiber array, a plurality of single-row polarization-maintaining fiber arrays can be directly stacked, and the stacking can be formed by gluing and fixing the adjacent single-row polarization-maintaining fiber arrays with cover plates adjacent to each other.

8. The method for assembly and calibration of polarization-maintaining fibers in co-packaged optics according to claim 6, wherein when packaging a multi-row polarization-maintaining fiber array, a plurality of single-row polarization-maintaining fiber arrays can be directly stacked, and the stacking can be formed by gluing and fixing the substrate of the top single-row polarization-maintaining fiber array with the cover plates of the bottom single-row polarization-maintaining fiber array to each other, and vice versa.

9. A system for assembly and calibration of polarization-maintaining fibers in co-packaged optics, applicable to calibrating the angles of a plurality of polarization-maintaining fibers in a plurality of V-shaped grooves arranged side by side on the substrate and each polarization-maintaining fiber having a bare fiber segment and a cladding segment, the system comprising:
a machine platform, provided with at least one low-frequency vibrator;
a carrier platform, provided on the machine platform, able to attach to and fix the substrate, and having a transparent stopper facing the substrate;
a carrier, installed above the machine platform through the low-frequency vibrator, provided with side-by-side accommodating grooves, wherein the bare fiber segment is located in the V-shaped groove, and the cladding segment is located in the accommodating groove, and the transparent stopper limits the length of the bare fiber segment extending out of the V-shaped groove;
a first pressing assembly, provided on the machine platform, comprising a first driving device, a cantilever, and a plurality of probe units provided on the cantilever; the first driving device able to drive the cantilever to rise and fall, and the probe able to rise and fall independently, able to exert pressure on the corresponding bare fiber segment when lowered;
a second pressing assembly, located on the machine platform, comprising a second driving device and a pressing part, the second driving device able to raise drive the pressing part to rise and fall, and able to exert pressure on the cladding segment; and
an optical inspection lens set, provided on the machine platform and located correspondingly to the substrate, and being used for photographing the end-face of the bare fiber segment.

10. The system for assembly and calibration of polarization-maintaining fibers in co-packaged optics according to claim 9, wherein the bottom of the machine platform is provided with a plurality of support feet, and the connection position between the support feet and the machine platform is provided with an adjustment assembly, the adjustment assembly can adjust the tilt angle of the machine platform, the tilt angle is to tilt the carried polarization-maintaining fiber from the cladding segment towards the bare fiber segment.

11. The system for assembly and calibration of polarization-maintaining fibers in co-packaged optics according to claim 9, wherein two low-frequency vibrators are provided and the top ends of the two low-frequency vibrators are respectively connected to both sides of the bottom of the carrier through slidable connectors, and the bottom of the low-frequency vibrator is fixed on the machine platform.

12. The system for assembly and calibration of polarization-maintaining fibers in co-packaged optics according to claim 9, wherein the low-frequency vibrator is a voice coil motor.
